(19) United States
(12) Patent Application Publication
(10) Pub. No.: US 2025/0181936 A1
(43) Pub. Date: Jun. 5, 2025

(54) SYSTEM AND METHOD FOR PREDICTING TIME-SERIES DATA

(71) Applicant: Electronics and Telecommunications Research Institute, Daejeon (KR)

(72) Inventors: GEUN YONG KIM, Daejeon (KR); Chorwon Kim, Daejeon (KR); HARK YOO, Daejeon (KR); HEE DO KIM, Daejeon (KR); Byung-Hee Son, Daejeon (KR)

(73) Assignee: Electronics and Telecommunications Research Institute, Daejeon (KR)

(21) Appl. No.: 18/963,008

(22) Filed: Nov. 27, 2024

(30) Foreign Application Priority Data
Nov. 30, 2023 (KR) 10-2023-0170938
Nov. 21, 2024 (KR) 10-2024-0167167

(51) Int. Cl. G06N 5/022

(52) U.S. Cl. CPC G06N 5/022

(57) ABSTRACT

Provided are a system and method for predicting time-series data. According to the system and method, first time-series data is externally input, and second time-series data which is time-series prediction data using an autoencoder-based time-series data prediction model (long-term time-series forecasting based on autoencoder (LTScoder)) is generated. The method includes an operation of receiving first time-series data, an encoding operation of inputting the first time-series data to an encoder of the model to generate a latent vector, a decoding operation of inputting the latent vector to a decoder of the model, and an operation of calculating a weighted sum of outputs of the decoder to generate second time-series data.

### CROSS-REFERENCE TO RELATED APPLICATION

This application claims priority to and the benefit of Korean Patent Application No. 2023-0170938, filed on Nov. 30, 2023, and No. 10-2024-0167167, filed on Nov. 21, 2024, the disclosures of which are incorporated herein by reference in their entirety.

### BACKGROUND

### 1. Field of the Invention

The present invention relates to a system and method for predicting a future value of time-series data through learning and inference of an artificial neural network model.

### 2. Discussion of Related Art

Time-series data is data collected over time. Time-series data is generally observed, recorded, or collected at regular time intervals. Time-series data is an important resource for analyzing and predicting changes in data according to time or date. Technology for analyzing and predicting time-series data is used for decision-making and planning in various field such as finance, weather, healthcare, production and manufacturing, social media, and the like. In addition, industrial sites rely on time-series data collected from various sensors to predict future trends and detect anomalies.

Lately, various time-series data prediction methods have been proposed. The main technology for time-series prediction started with a time-series prediction technique based on a statistical approach and evolved into prediction techniques employing artificial neural network models, such as a recurrent neural network (RNN) and a long short-term memory (LSTM), which learn and memorize correlations within time-series data. These days, transformer-based artificial neural network models are being proposed.

Statistical approaches to time-series prediction employ statistical methods and models to predict future time-series data on the basis of past data patterns. These methods are based on the assumption that future time-series actions are affected by past actions, and a representative method is an autoregressive integrated moving average (ARIMA) model. ARIMA involves an autoregressive (AR) model, a moving average (MA) model, and integration. The AR model extracts a temporal pattern, and the MA model extracts influence of errors of past time points. Integration is a technique used to remove irregularities in time-series data, ensuring data stability by calculating the difference between two consecutive points in time and removing trends and seasonality from time-series data. ARIMA shows good performance in predicting short-term trends and periodic patterns from static time-series data, but follow-up research has not been conducted on ARIMA in recent years since the advent of artificial neural network technology.

RNNs excel at sequential data processing and capture dependencies between consecutive time stages. However, existing RNNs have the disadvantage that, when the distance between input data and output data increases, the correlation decreases, which makes it difficult to effectively capture a long-term dependency.

LSTM networks are a variant of RNNs that mitigate this problem by incorporating gated memory cells that retain information over an extended period of time. LSTM models are appropriate for prediction tasks characterized by complex temporal relationships and non-stationary data, and several LSTM-based models are being proposed such as a gated recurrent unit (GRU).

These days, time-series prediction models based on a transformer architecture designed for natural language processing are attracting attention. Transformers have the ability to process a series of sequences in parallel on the basis of an attention mechanism. Accordingly, in contrast to RNNs and LSTMs, transformers can effectively model a long-range dependency, which is the dependency relationship between pieces of data that are far apart in time, using the mechanism of transformer self-attention. Transformer-based time-series data prediction models can dynamically evaluate the importance of each time stage during prediction.

The number of pieces of past data used in a computation to predict time-series data is referred to as a look-back window (LBW). Recent research has revealed that long-term time-series forecasting (LTSF) linear models have higher prediction accuracy than transformer-based models. LTSF linear models are models that predict future time-series data by linear computation of data in an LBW. LTSF linear models require a notably smaller amount of computation than transformer-based models, which is advantageous for system implementation, and thus are attracting great attention in the academic community.

FIG. 1 is a diagram of an LTSF linear model. As shown in FIG. 1, the LTSF linear model predicts M pieces of future data (each piece of data of a future time-series sequence) by linearly combining N pieces of data in an LBW. In FIG. 1, the N pieces of time-series data (D₁ to D_{N}) in the LBW are utilized to predict M pieces of time-series data (PD₁ to PD_{M}). Here, each time-series data prediction value PD_{X} is determined by adding the product of each piece of time-series data in the LBW and a weight W_{X,Y}. The weight W_{X,Y} is determined to reduce a mean squared error (MSE) through learning based on a training dataset. However, a problem of LTSF linear models is that all data in an LBW is given the same importance in predicting a future value. A proportion of each piece of the data in the LBW to be applied is adjusted in accordance with the value of the weight W_{X,Y}, but there is also a problem that data with little correlation is also involved in determining optimal weights for the artificial neural network model and thus acts as noise.

### SUMMARY OF THE INVENTION

The present invention is directed to providing a system and method for predicting time-series data that generate a latent vector (important data) by inputting data in a look-back window (LBW) to an artificial neural network model and predict a future value of time-series data on the basis of the latent vector.

Specifically, the present invention is directed to providing a device and method for predicting a future value of time-series data using an artificial neural network model that extracts features of past data to predict future time-series data while maintaining the order of data which is the feature of time-series data. The device and method according to the present invention model current time-series data as a signal, which is future time-series data mixed with noise, and predict time-series data on the basis of feature extraction and noise removal characteristics of an autoencoder.

Objects of the present invention are not limited to that described above, and other objects which have not been described will be clearly understood by those of ordinary skill in the art from the following description.

According to an aspect of the present invention, there is provided a method of predicting time-series data that is performed by a time-series data prediction system including a memory configured to store computer-readable instructions and an autoencoder-based time-series data prediction model and at least one processor configured to execute the instructions.

The method includes an operation in which the system receives first time-series data, an encoding operation in which the system inputs the first time-series data to an encoder of the model to generate a latent vector, a decoding operation in which the system inputs the latent vector to a decoder of the model, and an operation in which the system generates second time-series data by calculating a weighted sum of outputs of the decoder.

The method further includes an operation in which the system scales the first time-series data and an operation in which the system inversely scales the second time-series data.

The first time-series data may be data in a LBW of time-series data to be predicted.

The second time-series data may be time-series prediction data.

The system may include an edge device and a host device. The edge device may perform the operation of receiving the first time-series data and the encoding operation, and the host device may perform the decoding operation and the operation of generating the second time-series data.

In the model, a latent layer corresponding to the latent vector may be a last layer of the encoder and also a first layer of the decoder.

The latent vector may have a smaller number of dimensions than the first time-series data.

A first layer of the encoder may have the same number of neurons as a last layer of the decoder.

The model may be trained such that an error between the second time-series data and preset reference time-series data is reduced.

The model may have a structure in which the encoder and the decoder are alternately repeated two or more times.

In the model, each layer of the encoder may have the same number of neurons as a layer of the decoder symmetrical to the layer of the encoder with respect to the latent layer.

According to another aspect of the present invention, there is provided a system for predicting time-series data, the system including an edge device including a first memory configured to store a computer-readable first instruction and an encoder of an autoencoder-based time-series data prediction model, a first processor configured to execute the first instruction, and a first communication device, and a host device including a second memory configured to store a computer-readable second instruction and a decoder of the model, a second processor configured to execute the second instruction, and a second communication device.

The edge device receives first time-series data, inputs the first time-series data to the encoder to generate a latent vector, and transmits the latent vector to the second communication device through the first communication device.

The host device inputs the latent vector to the decoder and calculates a weighted sum of outputs of the decoder to generate second time-series data.

The first time-series data may be data in a LBW of time-series data to be predicted.

The second time-series data may be time-series prediction data.

In the model, a latent layer corresponding to the latent vector may be a last layer of the encoder and also a first layer of the decoder.

The latent vector may have a smaller number of dimensions than the first time-series data.

A first layer of the encoder may have the same number of neurons as a last layer of the decoder.

The model may have a structure in which the encoder and the decoder are alternately repeated two or more times.

In the model, each layer of the encoder may have the same number of neurons as a layer of the decoder that is symmetrical to the layer of the encoder with respect to the latent layer.

According to another aspect of the present invention, there is provided a system for predicting time-series data, the system including a memory configured to store computer-readable instructions and an autoencoder-based time-series data prediction model and at least one processor configured to execute the instructions.

The at least one processor receives first time-series data, inputs the first time-series data to an encoder of the model to generate a latent vector, inputs the latent vector to a decoder of the model, and calculates a weighted sum of outputs of the decoder to generate second time-series data.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram illustrating a long-term time-series forecasting (LTSF) linear model according to the related art;

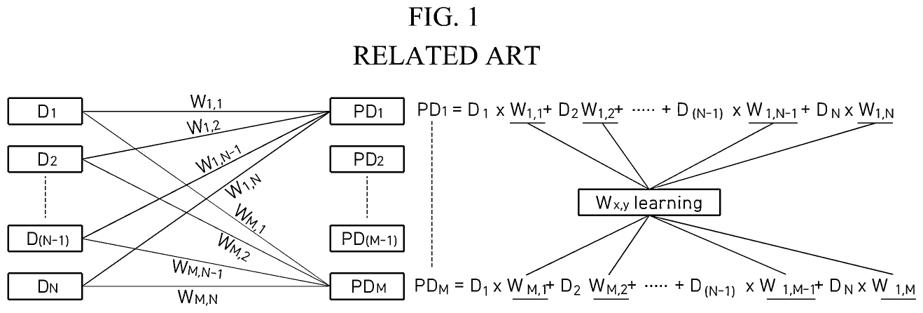

FIG. 2 is an exemplary diagram of a time-series data prediction model of the present invention;

FIG. 3 is a block diagram of a time-series data prediction system according to an exemplary embodiment of the present invention;

FIG. 4 is a diagram showing an encoder and a decoder of the time-series data prediction model of the present invention executed on different devices;

FIG. 5 is a flowchart illustrating a time-series data prediction method according to an exemplary embodiment of the present invention; and

FIG. 6 is a block diagram of a computer system for implementing a time-series data prediction method according to an exemplary embodiment of the present invention.

### DETAILED DESCRIPTION OF EXEMPLARY EMBODIMENTS

A long-term time-series forecasting based on autoencoder (LTScoder) used in the present invention is introduced in Non-Patent Document [1] below. The disclosure of Non-Patent Document [1] is incorporated herein by reference in its entirety.

[1] G. Kim, H. Yoo, C. Kim, R. Kim and S. Kim, “LTScoder: Long-Term Time Series Forecasting Based on a Linear Autoencoder Architecture,” in IEEE Access, vol. 12, pp. 98623-98633, 2024, doi: 10.1109/ACCESS.2024.3428479, https://ieeexplore.ieee.org/document/10599189.

Advantages and features of the present invention and methods of achieving them will become clear with reference to exemplary embodiments described below in detail in conjunction with the accompanying drawings. However, the present invention is not limited to the embodiments disclosed below and may be implemented in various different forms. The embodiments are provided only to make the disclosure of the present invention complete and fully convey the scope of the present invention to those skilled in the technical field to which the present invention pertains, and the present invention is only defined by the scope of the claims.

Terminology used herein is for describing the embodiments and is not intended to limit the present invention. In this specification, singular forms also include plural forms unless specifically stated otherwise. As used herein, “comprises” and/or “comprising” do not preclude the presence or addition of one or more components, steps, operations, and/or elements other than stated components, steps, operations, and/or elements.

Although the terms “first,” “second,” and the like may be used to describe various components, the components are not limited by the terms. These terms are only used to distinguish one component from others. For example, a first component may be named a second component, and similarly, a second component may be named a first component without departing the scope of the present invention.

When a component is referred to as being “connected” or “coupled” to another component, it should be understood that the two components may be directly coupled or connected to each other, or still another component may be interposed therebetween. On the other hand, when a component is referred to as being “directly connected” or “directly coupled” to another component, it should be understood that there is no intermediate component. Other expressions describing relationships between components, such as “between,” “directly between,” “neighboring,” “directly neighboring,” and the like, should be similarly interpreted.

In describing the present invention, detailed description of associated well-known technology that is determined to unnecessarily obscure the subject matter of the present invention will be omitted.

Hereinafter, exemplary embodiments of the present invention will be described in detail with reference to the accompanying drawings. In describing the present invention, to facilitate overall understanding, the same reference numeral will be used for the same element throughout the drawings.

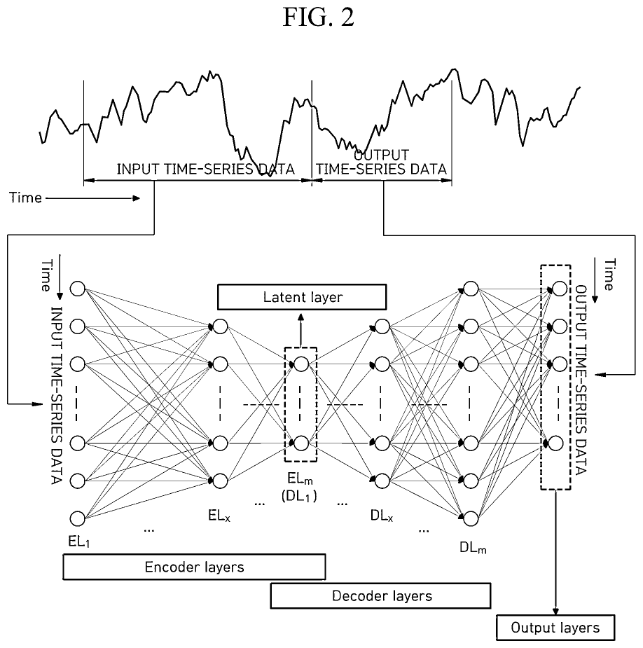

FIG. 2 is an exemplary diagram of a time-series data prediction model of the present invention.

In this specification, an autoencoder-based time-series prediction model proposed in the present invention is named “LTScoder.” An autoencoder is an artificial neural network architecture that is designed to encode original data into a main feature (latent vector), which is a compressed expression, and then restore the original data by decoding the latent vector. The autoencoder is mainly used for dimensionality reduction and feature extraction. The autoencoder learns a method of encoding original data into a low-dimensional expression and then restoring the original data using the low-dimensional expression, and thus is utilized in various tasks such as detecting an intrinsic feature of data, noise removal, dimensionality reduction, feature extraction, generative modeling, and the like.

Input time-series data (also referred to as “first time-series data”) of FIG. 2 is data input to the LTScoder. The input time-series data may be data that is scaled to a value within a specific range to increase training efficiency of the LTScoder. When scaled data is used as input time-series data to train the LTScoder, it is necessary to also use scaled data as input time-series data for inference. When scaled input time-series data is input to the LTScoder, an inverse scaling task is required for output time-series data.

Various scaling techniques may be used to scale input time-series data or inversely scale output time-series data. For example, standard scaling or min-max scaling may be used.

In FIG. 2, small circles represent neurons that are generally indicated in an artificial neural network model. Arrows (synapses) connecting the neurons represent weight multiplication operations. Accordingly, each neuron is calculated as the weighted sum of all neurons in a plurality of preceding stages (previous layers).

The LTScoder includes encoder layers, decoder layers, and an output layer. The encoder layers, the decoder layers, and the output layer may be referred to as an encoder, a decoder, and an output of the LTScoder, respectively. The encoder layers include a plurality of layers, and the decoder layers include a plurality of layers. The encoder layers and the decoder layers share a latent layer. The latent layer (ELₘ, DL₁) is the last of the encoder layers and also the first of the decoder layers. Each neuron of the latent layer constitutes a latent vector. Each of the encoder layers EL₁ . . . , and ELₘ may have the same number of neurons as one of the decoder layers DL₁, . . . , DLₘ that are symmetrical to the encoder layer with respect to the latent layer.

The encoder layers receive input time-series data through the first encoder layer EL₁ to generate a latent vector. In the present invention, a latent vector may be a significant value for predicting a future value of time-series data. Here, the “significant value” is a value for reducing the mean squared error (MSE) between predicted time-series data and actual future time-series data. As described above, neurons generated in the last stage of the encoder layers are referred to as the latent layer (or a bottleneck layer), and these neurons are used to predict future time-series data.

The decoder layers generate output time-series data from neurons of the latent layer. As described above, in the structure of the artificial neural network model, the decoder layers are symmetrical to the encoder layers. For example, when the number of pieces of input time-series data is N, the encoder layers may be three layers including a layer composed of N/2 neurons as a second layer EL₂ and a latent layer EL₃ (=DL₁) composed of L neurons as the last layer. In this case, the decoder layers may also include the latent layer DL₁, a layer DL₂ composed of N/2 neurons, and a consecutive layer DL₃ composed of N neurons.

Each neuron of the output layer connected to the decoder layers is calculated as a linear combination of N neurons included in the last of the decoder layers.

The LTScoder proposed in the present invention can generate a significant value for predicting output data through a smaller number of neurons in a latent layer than pieces of input data, improving accuracy compared to a transformer or a long-term time-series forecasting (LTSF) linear model according to the related art. In the example of FIG. 2, the LTScoder only includes one pair of an encoder and a decoder (one encoder-decoder structure), but the structure may be repeated. For example, it is self-evident that the LTScoder may have an encoder-decoder-encoder-decoder structure. Meanwhile, as activation functions used in training the LTScoder, various functions including Linear, ReLU, Sigmoid, and the like may be used, and Dropout EarlyStopping may also apply during training.

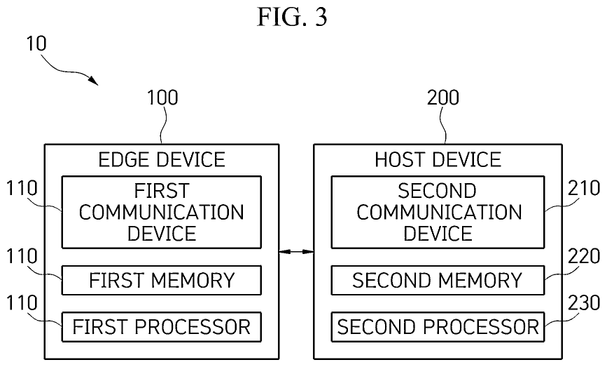

FIGS. 3 to 5 are diagrams illustrating a system and method for predicting time-series data using an LTScoder. For example, the system or method shown in FIGS. 3 to 5 can predict time-series data using the LTScoder of FIG. 2.

FIG. 3 is a block diagram of a time-series data prediction system according to an exemplary embodiment of the present invention.

Referring to FIG. 3, a time-series data prediction system 10 according to an exemplary embodiment of the present invention includes an edge device 100 and a host device 200.

The edge device 100 includes a first communication device 110, a first memory 120 and a first processor 130, and the host device 200 includes a second communication device 210, a second memory 220, and a second processor 230.

The first communication device 110 and the second communication device 210 transmit and receive data with each other using a wireless communication method or a wired communication method.

The edge device 100 and the host device 200 shown in FIG. 3 are in accordance with an exemplary embodiment. Components of the edge device 100 and the host device 200 according to the present invention are not limited to the exemplary embodiment shown in FIG. 3 and may be added, changed, or removed as necessary.

The first memory 120 of the edge device 100 stores a computer-readable first instruction (an instruction executed by the first processor 130), and an encoder of an autoencoder-based time-series data prediction model. The first processor 130 of the edge device 100 is implemented to execute the first instruction.

The second memory 220 of the host device 200 stores a computer-readable second instruction (an instruction executed by the second processor 230), and a decoder of the model. The second processor 230 of the host device 200 is implemented to execute the second instruction.

The edge device 100 externally receives first time-series data through the first communication device 110. The first time-series data may be data in a look-back window (LBW) of time-series data to be predicted. For example, the first time-series data may be traffic volume data of a specific period in the past.

The first processor 130 executes the first instruction stored in the first memory 120 and inputs the first time-series data to the encoder of the model to generate a latent vector. The edge device 100 transmits the latent vector to the second communication device 210 of the host device 200 through the first communication device 110.

The second processor 230 of the host device 200 executes the second instruction stored in the second memory 220, inputs the latent vector generated by the edge device 100 to the decoder of the model, and calculates a weighted sum of outputs of the decoder to generate second time-series data.

The second time-series data may be time-series prediction data. In other words, the second time-series data may be a prediction result for time-series data. For example, the second time-series data may be traffic volume data of a specific period in the future.

As described above in FIG. 2, a latent layer corresponding to the latent vector in the model may be the last layer of the encoder of the model and also the first layer of the decoder of the model. The latent vector may have a smaller number of dimensions than the first time-series data, and the first layer of the encoder may have the same number of neurons as a last layer of the decoder. Each layer of the encoder may have the same number of neurons as a layer of the decoder that is symmetrical to the layer of the encoder with respect to the latent layer (see FIG. 2).

The model may include one encoder and one decoder or may have a structure in which the encoder and the decoder are alternately repeated two or more times. For example, the model may have a structure in which the encoder and the decoder are alternately repeated two times such as an encoder-decoder-encoder-decoder structure.

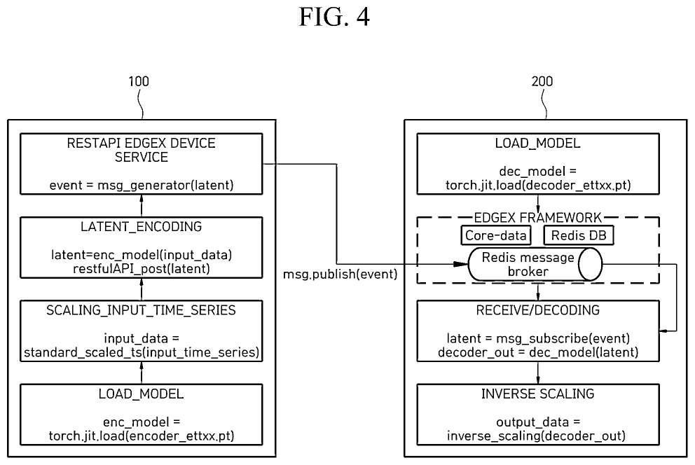

FIG. 4 is a diagram showing an encoder and a decoder of the time-series data prediction model of the present invention executed on different devices.

The strength of the LTScoder is its ability to separate encoders and decoders, performing computations on different devices to optimize resource utilization in an edge computing environment. As shown in FIG. 4, the edge device 100 generates a latent vector through an encoder, and the host device 200 receives the latent vector from the edge device 100 and predicts future time-series data.

Specifically, as shown in FIG. 4, the edge device 100 loads an encoder part of the LTScoder, generates a latent vector by scaling and encoding input time-series data, and then transmits the generated latent vector to the host device 200. The host device 200 loads a decoder part of the LTScoder, generates an output of the decoder by inputting the received latent vector to the decoder, and acquires output time-series data by inversely scaling the output of the decoder.

The encoder-decoder separation method of the LTScoder has the following advantages.

1) Resource optimization: Computational resources can be efficiently utilized by separating encoding and decoding tasks. The edge device 100 that handles encoding generates a latent vector from input data, and the host device 200 that handles decoding generates an output from the latent vector. In this way, encoding computations and decoding computations are performed on different devices. This allows parts of a process to run in parallel, minimizing required processing time.

2) Short latency: The edge device 100 focuses on data collection and latent vector generation, whereas the host device 200 specializes in a decoding process for rapidly analyzing received data and generating a response on time. This setting leads to a short latency and allows rapid decision-making based on predicted time-series data.

3) Scalability: There are several benefits to integrating several lightweight edge devices 100 with the high-performance host device 200. Since edge devices 100 can be easily added or removed, it is possible to have scalability that satisfies variable application requirements without significantly redesigning or reconfiguring the overall time-series data prediction system 10. In the present embodiment, the edge device that implements an encoder is only required to transmit a latent vector to the host device 200 that implements a decoder, and thus it is possible to implement a scalable edge computing environment.

Meanwhile, even if omitted from the description of FIGS. 3 and 4, the description of FIG. 2 is applicable to the description of FIGS. 3 and 4. Also, the description of FIGS. 3 and 4 is applicable to the description of FIG. 2.

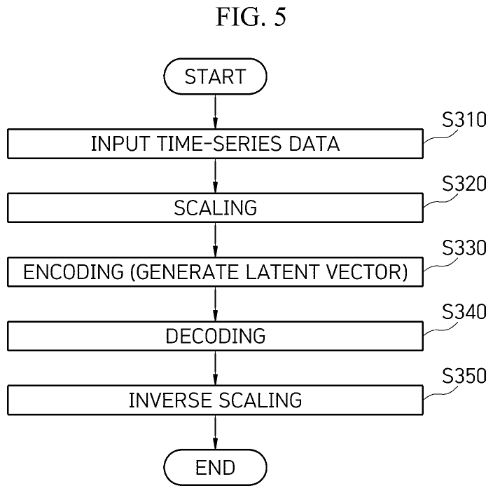

FIG. 5 is a flowchart illustrating a time-series data prediction method according to an exemplary embodiment of the present invention.

Referring to FIG. 5, the time-series data prediction method according to an exemplary embodiment of the present invention includes operations S310 to S350. The time-series data prediction method shown in FIG. 5 is in accordance with an exemplary embodiment, and operations of a time-series data prediction method according to the present invention are not limited to the exemplary embodiment shown in FIG. 5 and may be added, changed, or removed as necessary. For example, operations S320 and S350 may be omitted.

For convenience of description, the time-series data prediction method of FIG. 5 is assumed to be performed by the time-series data prediction system 10 that includes a memory storing computer-readable instructions and an LTScoder, which is an autoencoder-based time-series data prediction model, and at least one processor implemented to execute the instructions. In the present embodiment, an encoder of the LTScoder is stored in the edge device 100, and a decoder of the LTScoder is stored in the host device 200.

The edge device 100 receives first time-series data (S310). The first time-series data may be data in an LBW of time-series data to be predicted.

Then, the edge device 100 scales the first time-series data (S320).

Subsequently, the edge device 100 generates a latent vector by inputting the first time-series data to the encoder of the LTScoder and transmits the latent vector to the host device 200 (encoding operation, S330).

Then, the host device 200 inputs the latent vector to the decoder of the LTScoder and generates second time-series data by calculating a weighted sum of outputs of the decoder (decoding operation, S340). When operations S320 and S350 are omitted, the second time-series data becomes final time-series prediction data.

Subsequently, the host device 200 acquires final time-series prediction data by inversely scaling the second time-series data (S350).

In the LTScoder, a latent layer corresponding to the latent vector may be the last layer of the encoder and also the first layer of the decoder. Here, the latent vector may have a smaller number of dimensions than the first time-series data. The first layer of the encoder of the LTScoder may have the same number of neurons as the last layer of the decoder of the LTScoder.

The encoder and decoder of the LTScoder may be symmetrical to each other with respect to the latent layer. In other words, layers of the encoder and decoder which are symmetrical to each other with respect to the latent layer may have the same number of neurons.

The LTScoder may have a structure in which an encoder and a decoder are alternately repeated two or more times. It is self-evident that the LTScoder may only include one encoder and one decoder.

Meanwhile, the LTScoder may be trained such that an error between the second time-series data generated by the decoder during training and preset reference time-series data is reduced.

The time-series data prediction method has been described above with reference to the flowchart shown in the drawing. Although the method has been illustrated as a series of blocks and described for convenience, the present invention is not limited to the order of the blocks. Some blocks may be performed in a different order than shown and described herein or performed at the same time as other blocks, and various other branches, flow paths, and sequences of blocks that achieve the same or similar results may be implemented. Also, not all the blocks shown in the drawing may be required for implementing the method described herein.

In the description of FIG. 5, according to implementation of the present invention, each operation may be subdivided into additional operations, or the operations may be combined into fewer operations. As necessary, some operations may be omitted, and the sequence of operations may be changed. Also, the description of FIGS. 2 to 4 is applicable to FIG. 5 even if omitted. The description of FIG. 5 is likewise applicable to the description of FIGS. 2 to 4.

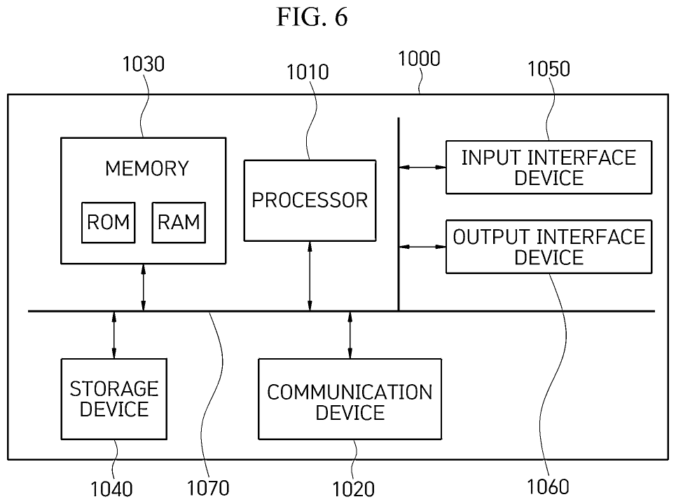

FIG. 6 is a block diagram of a computer system for implementing a time-series data prediction method according to an exemplary embodiment of the present invention. The edge device 100 or the host device 200 may be implemented in the form of a computer system 1000 of FIG. 6. The computer system 1000 of FIG. 6 may perform all computations of an LTScoder.

Referring to FIG. 6, a computer system 1000 may include at least one of at least one processor 1010, a memory 1030, an input interface device 1050, an output interface device 1060, and a storage device 1040 that communicate via a bus 1070. The computer system 1000 may further include a communication device 1020 connected to a network. The processor 1010 may be a central processing unit (CPU) or a semiconductor device that executes computer-readable instructions stored in the memory 1030 or the storage device 1040. The memory 1030 and the storage device 1040 may include various forms of volatile or non-volatile storage media. For example, the memory 1030 may include a read-only memory (ROM) and a random access memory (RAM). In an exemplary embodiment of the present disclosure, the memory 1030 may be inside or outside the processor 1010 and connected to the processor 1010 via various known devices. The memory 1030 is any of a variety of forms of volatile or non-volatile storage media. For example, the memory 1030 may include a ROM or a RAM.

Therefore, an exemplary embodiment of the present invention may be implemented as a method implemented by a computer or as a non-transitory computer-readable medium in which computer-executable instructions are stored. In an exemplary embodiment, when executed by the processor 1010, the computer-readable instructions may perform a method according to at least one aspect of the present disclosure.

The communication device 1020 may transmit or receive a wired signal or a wireless signal.

The time-series data prediction method according to an exemplary embodiment of the present invention can be implemented in the form of program instructions that are executable by various computing devices, and recorded on a computer-readable medium.

The computer-readable medium may include program instructions, data files, data structures, and the like solely or in combination. The program instructions recorded on the computer-readable medium may be specially designed for exemplary embodiments of the present invention or well known and available to those of ordinary skill in the field of computer software. The computer-readable recording medium may include a hardware device configured to store and execute program instructions. Examples of the computer-readable recording medium may be magnetic media such as a hard disk, a floppy disk, and magnetic tape, optical media such as a CD-ROM and a DVD, magneto-optical media such as a floptical disk, a ROM, a RAM, a flash memory, and the like. The program instructions may include not only machine code such as that created by a compiler but also high-level language code that is executable by a computer using an interpreter or the like.

By executing the computer-readable instructions stored in the memory 1030 or the storage device 1040, the processor 1010 may receive first time-series data, generate a latent vector by inputting the first time-series data to an encoder of an LTScoder, input the latent vector to a decoder of the LTScoder, and generate second time-series data by calculating a weighted sum of outputs of the decoder. A detailed computational process in which the processor 1010 predicts time-series data using the LTScoder may be understood with reference to FIG. 2. The description of FIGS. 2 to 5 is applicable to the description of FIG. 5.

The present invention proposes an artificial neural network model that generates important data required for predicting a future value from data in an LBW and then predicts future time-series data. The artificial neural network model proposed in the present invention can be utilized for future prediction, decision making, and planning in various fields such as finance, weather, healthcare, production and manufacturing, social media, and the like. In particular, the artificial neural network model can be utilized to predict future trends and detect anomalies on the basis of data collected from various sensors in industrial sites.

Effects of the present invention are not limited to those described above, and other effects which have not been described will be clearly understood by those of ordinary skill in the art from the above description.

Although exemplary embodiments of the present invention have been described above, those of ordinary skill in the art should understand that various modifications and alterations can be made without departing from the spirit and scope of the present invention stated in the following claims.

What is claimed is:

1. A method of predicting time-series data which is performed by a time-series data prediction system including a memory configured to store computer-readable instructions and an autoencoder-based time-series data prediction model and at least one processor configured to execute the instructions, the method comprising:
an operation in which the system receives first time-series data;
an encoding operation in which the system inputs the first time-series data to an encoder of the model to generate a latent vector;
a decoding operation in which the system inputs the latent vector to a decoder of the model; and
an operation in which the system generates second time-series data by calculating a weighted sum of outputs of the decoder.

2. The method of claim 1, further comprising:
an operation in which the system scales the first time-series data; and
an operation in which the system inversely scales the second time-series data.

3. The method of claim 1, wherein the first time-series data is data in a look-back window (LBW) of time-series data to be predicted.

4. The method of claim 1, wherein the second time-series data is time-series prediction data.

5. The method of claim 1, wherein the system includes an edge device and a host device,
the edge device performs the operation of receiving the first time-series data and the encoding operation, and
the host device performs the decoding operation and the operation of generating the second time-series data.

6. The method of claim 1, wherein, in the model, a latent layer corresponding to the latent vector is a last layer of the encoder and also a first layer of the decoder.

7. The method of claim 1, wherein the latent vector has a smaller number of dimensions than the first time-series data.

8. The method of claim 1, wherein a first layer of the encoder has the same number of neurons as a last layer of the decoder.

9. The method of claim 1, wherein the model is trained such that an error between the second time-series data and preset reference time-series data is reduced.

10. The method of claim 1, wherein the model has a structure in which the encoder and the decoder are alternately repeated two or more times.

11. The method of claim 6, wherein, in the model, each layer of the encoder has the same number of neurons as a layer of the decoder symmetrical to the layer of the encoder with respect to the latent layer.

12. A system for predicting time-series data, the system comprising:
an edge device including a first memory configured to store a computer-readable first instruction and an encoder of an autoencoder-based time-series data prediction model, a first processor configured to execute the first instruction, and a first communication device; and
a host device including a second memory configured to store a computer-readable second instruction and a decoder of the model, a second processor configured to execute the second instruction, and a second communication device,
wherein the edge device receives first time-series data, inputs the first time-series data to the encoder to generate a latent vector, and transmits the latent vector to the second communication device through the first communication device, and
the host device inputs the latent vector to the decoder and calculates a weighted sum of outputs of the decoder to generate second time-series data.

13. The system of claim 12, wherein the first time-series data is data in a look-back window (LBW) of time-series data to be predicted.

14. The system of claim 12, wherein the second time-series data is time-series prediction data.

15. The system of claim 12, wherein, in the model, a latent layer corresponding to the latent vector is a last layer of the encoder and also a first layer of the decoder.

16. The system of claim 12, wherein the latent vector has a smaller number of dimensions than the first time-series data.

17. The system of claim 12, wherein a first layer of the encoder has the same number of neurons as a last layer of the decoder.

18. The system of claim 12, wherein the model has a structure in which the encoder and the decoder are alternately repeated two or more times.

19. The system of claim 15, wherein, in the model, each layer of the encoder has the same number of neurons as a layer of the decoder that is symmetrical to the layer of the encoder with respect to the latent layer.

20. A system for predicting time-series data, the system comprising:
a memory configured to store computer-readable instructions and an autoencoder-based time-series data prediction model; and
at least one processor configured to execute the instructions,
wherein the at least one processor receives first time-series data, inputs the first time-series data to an encoder of the model to generate a latent vector, inputs the latent vector to a decoder of the model, and calculates a weighted sum of outputs of the decoder to generate second time-series data.
